(19) United States
(12) Patent Application Publication
(10) Pub. No.: US 2004/0158176 A1
(43) Pub. Date: Aug. 12, 2004

(54) Hot acupressure and massage machine

(76) Inventor: Joon Park, Glendale, CA (US)

Correspondence Address: ALLEN A. DICKE, JR., 224 MALL WAY, ANAHEIM, CA, 92804, US

(21) Appl. No.: 10/762,649

(22) Filed: Jan. 21, 2004

Related U.S. Application Data
(60) Provisional application No. 60/443,406, filed on Jan. 29, 2003.
(60) Provisional application No. 60/503,507, filed on Sep. 15, 2003.

(51) Int. Cl. A61H 7/00

(52) U.S. Cl. 601/18; 601/100; 601/103; 601/134

(57) ABSTRACT

A hot-Acupressure and Massage machine provides conforming to the individual user's spinal shape and accommodating capability for a range of user heights. A hot-Acupressure and Massage machine has a heat-transmitter module that reciprocates under the user's back with the following provisions: a support surface, a module with a total compliance means to the spine by including a ball-socket mechanism and actuator(s), a variable compression means to the user's back from the module to allow the user to choose compressions levels for both effectiveness and comfort, a set of raised pads to help align a user to the module, a slidable headrest that adjusts to the user's height, an elevated support surface for the thighs and feet, and a belt to treat the chest, abdominal, joints, and hip areas.

### CROSS-REFERENCE TO RELATED APPLICATION

This application fully incorporates by reference the contents of and relies for priority on U.S. Provisional Application No. 60/443,406, entitled “Method and Apparatus for a Treatment, Therapy, and Massage Bed that Conforms to the Spine and Accommodates Different Human Height” filed Jan. 29, 2003, and U.S. Provisional Application No. 60/503,507, entitled “Hot-Acupressure and Massage Machine” filed Sep. 15, 2003.

### FIELD OF THE INVENTION

This invention is directed to a hot-acupressure and massage implement and method, and more particularly, to a hot-acupressure and massage machine, implement and method that provides conformity to and comfort for the human body, particularly the spine. This implement further provides an adjustable treatment module with longitudinal stroke to accommodate various human heights by the movement of a pillow.

### BACKGROUND OF THE INVENTION

Lately, there has been much progress in developing massage, therapy, and treatment beds to treat and massage back pain and internal organs. In particular, the use of transmitting thermal energy to the nervous system in the vertebrae region and to the internal organs has proved more effective than the use of acupressure or other means to cure many diseases and to relieve fatigue; transmitting thermal energy stimulates the muscular and nervous system and helps the circulation of blood. A conventional hyperthermo-therapeutical apparatus includes a heater that emits thermal energy to the spinal area, more particularly to the vertebral acupuncture point of a user lying on a bed, by applying a hot compress that provides reciprocal motion generated by a motor. This hot compress unit is centrally and longitudinally located on the bed, which also has two adjacent lateral mat surface areas provided for the user to lie on.

The first-time user can experience a severe amount of pain with this type of conventional apparatus. Since the user's weight rests on the top of the heater unit, which is substantially higher than the two side mat surface areas of the bed, the compression force induced by the weight of the user causes large amounts of pain and discomfort on his/her back. The reciprocating heater unit travels on the plane of the bed in the horizontal direction, along the user's spine; the user experiences different compressions at different spinal sections. The thoracic and sacral regions are lower than the cervical and lumbar regions when a user lies down on the bed; therefore, the uneven compression induced by the heater unit will cause not only the varying treatments by regions, but also discomfort due to severe compression, especially on the thoracic region. Even though a hot-compress treatment bed by U.S. Pat. No. 6,454,732 and U.S. Pat. No. 6,606,520 introduced a partial solution for this problem by providing two pairs of fixed cams on the rail to raise the reciprocating heater unit at or near the cervical and lumbar region, this still cannot accommodate the unique characteristics of each individual's spine curvature shape.

Furthermore, the stroke of reciprocation in the currently existing treatment beds is generally fixed for the median population; therefore, the treatment bed is not readily adaptable for those who are too short and too tall. These non user-friendly features, which include the inconvenience, ineffectiveness, and non-adaptability to the wide population, limit the usage of these hot compress beds.

Therefore, it is desirable to provide a hot-acupressure and massage implement with flexibility to provide a treatment, therapy and massage to any users in a friendly, comfortable, and efficient manner with one or more of the following features:

1) the ability to automatically adjust the longitudinal stroke of the hot-acupressure and massage module according to user's height; 2) the ability to adjust the angle or/and height of the main mat and the foot section mat for comfort; 3) the ability to help the user's correct/aligned position by orthotic pads; 4) the ability to comply to the shape of the individual's spine; 5) the ability to adjust/choose compression force on the user's back; 6) the ability to simulate human thumb pressure and modes as practiced by therapists; 7) the ability to fill open spaces between the hot-acupressure and massage modules in the track by plates; 8) the ability to treat the chest, abdominal, joints, and/or hip areas with at least one belt; 9) the ability to provide auxiliary appliances or table while the user is using the machine and to provide arm rests; and 10) the ability to provide safety of this machine to stop whenever the user's high blood pressure level is detected.

### SUMMARY OF THE INVENTION

Transmission of far-infrared rays from light bulbs and Jade caps, electromagnetic field, and kneading/massaging to the spine region, which is the aggregate of the nerve line, is basic to the principle of treatment. This warm heat to the muscles and nerve tissues of the spinal region directly stimulates the flow of blood (i.e., circulation) and simultaneously relaxes the tendons and muscles around the back, resulting in the recovery of the body's power and energy. It is known that the low frequency electromagnetic field decreases the amount of osteoporosis and stimulates bone mineralization. Using this technique and technology in a proper way will contribute to the good health of the human being.

In an exemplary embodiment according to the present invention, a hot-acupressure and massage implement is provided. The implement includes a body having a bed or a chair for a user to lie down on said bed or to sit on said chair, wherein said body has at least one hot-acupressure module that travels longitudinally under said user's back, wherein said body may have a pillow to stop and to reverse the reciprocating module automatically so that the implement fits the user's height, wherein the lower end of said pillow may be slidably disposed on the implement.

In another aspect according to the present invention, the implement includes a main mat for the user's head and back, a joining mat for the thigh (upper leg), and a feet mat for the feet, wherein said main mat and said feet mat may have a means to adjust the angle and/or height of said main mat and said feet mat so as to provide the user better circulation of blood, more comfort, faster fatigue relief, and more effective treatment.

In yet another aspect according to the present invention, the implement may have at least one pair of raised orthotic pads disposed on main mat so as to help/align the user's correct position above a hot-acupressure module and to help/correct abnormal spinal conditions such as scoliosis, spondylolisthesis, Kyphosis, and lordotic.

In still another aspect according to the present invention, the implement includes a body having a module that may have at least one of the following: thermal energy emitter, electromagnet generation device, and massaging/kneading device, wherein said module may have a compliance means according to the shape of the user's spinal curvature.

In still another aspect according to the present invention, the implement includes at least an actuator that may provide a variable compression force from the acupressure module to the user's back so as for the user to choose proper levels of compression force and/or modes to his/her back to simulate human thumb pressure as practiced by therapists.

In still another aspect according to the present invention, the implement includes a module that may comprise of the following: heat-transmitter/thermal energy emitter, electromagnet generation device, and massaging/kneading device, wherein at least an actuator may provide a variable compression force, wherein said actuator provides said compression force continuously/intermittently and/or on/off modes from said module to the user's back so as to simulate human thumb pressure as practiced by therapists.

In still another aspect according to the present invention, the implement includes at least two floating plates that are placed longitudinally adjoining to said module and is positioned substantially lower than the surface of said bed or chair so as to fill the space in said track.

In still another aspect according to the present invention, the implement may have at least one belt module to treat the chest, abdominal, hip, thighs, joints, and feet areas and the said belt module may comprise of the following: thermal energy emitter, electromagnet generation device, and massaging/kneading device.

In still another aspect according to the present invention, the implement may have at least one bracket mounted on the side wall of said body so as to mount a structure to install auxiliary appliances or table while the user is using said body, wherein said bed or chair may have one pair of arm rest brackets mounted on said body.

In a further aspect according to the present invention, the implement may have a control for the operation of said hot-acupressure module for the user's safety, wherein said module may stop whenever user's high blood pressure level is detected.

The many features and advantages of the present invention will become more apparent from the following detailed description taken in conjunction with the accompanying drawings, which disclose, by way of example, the principles of the invention.

### BRIEF DESCRIPTION OF THE DRAWINGS

These and other aspects of the invention may be understood by reference to the following detailed description, taken in conjunction with the accompanying drawings, wherein:

FIG. 1 is a top view of the treatment, therapy, and massage implement of the exemplary embodiment 5 in accordance with the present invention with a partial view showing a longitudinally located track 7 that houses a saddle 9, a treatment module 8, and a headrest assembly 10;

FIG. 2 is a plane and partial sectional view of the track 7 showing the module 8′ complied with the neck cervical curvature 4 of a taller user 2 lying on the embodiment 5. Dash-dot lines represent a shorter user 1 with a full spine;

FIG. 3 is a cross-sectional view taken along line 3-3 of FIG. 2 with the taller user 2, the module 8, and the saddle 9 inside of the track 7;

FIG. 4 is a top view of the treatment, therapy, and massage module 8;

FIG. 5 is a side cross-sectional view taken along line 5-5 of FIG. 4 of the module 8 that is mounted above the saddle 9, which is movable on the track 7; the module 8 is shown at a clockwise tilted lateral position;

FIG. 6 is a plane cross-sectional view taken along the line 6-6 of FIG. 5, showing the module 8, the saddle 9, and the track 7; The module 8 is tilted clockwise longitudinally, which is the same view shown in FIG. 1 at the location under the neck cervical curvature 4 of the taller user 2. The sectional view of the slidable headrest assembly 10 is also shown;

FIG. 7 is a top partial cross-sectional view taken along the line 7-7 of FIG. 5, showing the saddle 9 that houses a switch plunger rod, two switches that trigger to reverse the travel direction, and one power shut-off switch; A switch bracket is positioned to activate the plunger rod and is extended from a locking cam, which is a lower portion of the headrest assembly 10; One of two opposite and laterally disposed locking cams is secured in the channels that are part of the track 7; This also shows the saddle 9 that rides on the channel on which a pair of ball bearings is placed longitudinally.

### DESCRIPTION OF THE PREFERRED EMBODIMENT

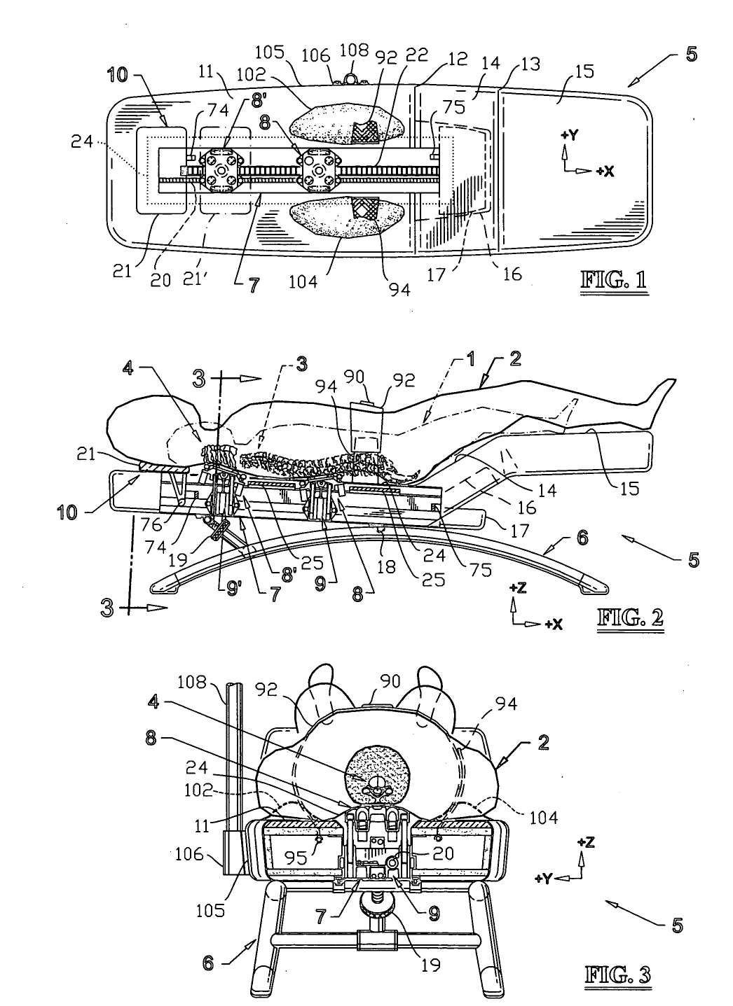

The hot-acupressure and massage bed or chair implement/machine in exemplary embodiment 5 (or a body thereof) according to the present invention is illustrated as top, plane, and side views in FIGS. 1, 2, and 3, respectively. The body 5 may generally be a sleeping bed or a chair shape that may be narrower in the lateral direction having a main mat 11, a joining mat 14, a feet mat 15, and a frame 6. A track 7 may be longitudinally positioned (along the X-axis) inside a main mat 11 to house a power screw 20 that may be rotated by a motor and a wire/tube carrier 22. As the screw 20 is rotated, the saddle 9 that is engaged to the screw 20 can start in the position as shown and reach the user's neck area by moving in the −X direction; then, a switch bracket 74 of the headrest 10 triggers a switch to reverse the direction of the saddle 9 from the −X to +X direction. Similarly, there may be another switch bracket 75 at the other end of the body 5 to reverse the direction of the saddle 9 from the +X to −X direction so as to generate a reciprocating movement of the saddle 9. This reciprocation may be achieved silently and smoothly by a (shaftless) linear motor that does not require the screw 20, a mating nut and mounting hardware. Coupling the motor with a positional feedback such as an encoder may enable the user to program the saddle 9 to stop and reverse its direction when it is near the user's head. A sheet of covering 24 is placed above the track on the top of module 8 to minimize rubbing on the back of the user. At least a hot-compress and massage module 8 may be coupled onto the saddle 9, both of which are reciprocating on the track 7. The module 8 may provide at least one of the following devices: thermal energy emitters, electromagnet generation devices, ion generator, and massaging/kneading to provide treatment, therapy, and massage.

A shorter user 1 (shown with full spine 3 only) is represented with a dash-dot line, which represents females in the lowest 5^{th} percentile of height (i.e., females of shortest height). A taller user 2 (shown with neck cervical curvature 4 only) is represented with a solid line, which represents males in the upper 95^{th} percentile of height (i.e., males of tallest height). Even though the length of the spine is not proportional to the height of the individual, there are variations from one individual to the other. Therefore, the travel of saddle 9 should be adjusted according to the individual's spinal length or from hip to neck. The headrest 10 may be slidably movable; for example, the taller user 2 can adjust the location of pillow 21, and the shorter user 1 can adjust the location of pillow 21′. Therefore, the module 8 on the saddle 9 travels from underneath the coccyx to the cervical of each user regardless of the user's height. Furthermore, this module 8 complies with the curvature of the spine as shown in FIG. 2.

The body 5 may consist of three sections: a main mat 11, a joining mat 14, and a feet mat 15. These are partially bendable with respect to each other at transition joints 12 and 13. There are various mechanisms to manipulate the feet mat 15 to rise counterclockwise from the normal lowered elevation. As an example, the feet mat 15 may be moved up (+Z) to be substantially parallel to the main mat 11 by two pivot joints 12 and 13, and by a pair of two bar mechanisms connecting the main mat 11 and the feet mat 15. The raised feet mat 15 may be held by a ratchet mechanism at any desired position, and at the end of the raised position the ratchet can be freed by releasing a pawl, which would reset the feet mat 15 to the lowered position. A recessed pocket 16, which is provided underneath the joining mat 14, does not interfere with the main mat extension 17 that may contain the motor and control units. The main mat 11 may be tilted clockwise about a pivot 18 for the comfort of the user up to 45° by either using latch and quick-release mechanisms or by rotating jack handle 19, which connects lower end of the main mat 11 to the frame 6. Alternatively, adjustments for positions, such as tilting the main mat 11 and raising the feet mat 15, may be easily implemented with electric actuators at the touch of a button. The joining mat 14 may be extendable longitudinally for different lengths of the user's thighs. Utilization of actuators may enable repeating clockwise and counter-clockwise directional angular movement of mats 11, 14, and 15 about pivots 12 and 13. This may provide treatment to the user's hip socket and leg joints with the belt module 90 that provides far-infrared rays, electromagnet forces, and massaging. Since it takes about thirty to ninety minutes daily for the treatment, especially the position of the feet may be elevated for better circulation of blood, which gives the user more comfort, faster fatigue relief, and more effective treatment.

In another exemplary embodiment according to the present invention, one pair of raised orthotic pads 102 and 104 are oppositely disposed adjoining to the track 7 and above on the lower end (+X) of main mat 11 surface to help/align the user 1 or 2 when the user lies down on the mat, as shown in FIGS. 1 and 3. The distance between two pads 102 and 104 can be configured from the median population as vehicle front seats and also can be adjusted/manipulated by the introduction of various self-centering mechanisms. Even though these pads 102 and 104 may be made of elastic sponge material, these may be air bags that may be inflatable by users for their fit and comfort. The correct alignment of the spine 3 or 4 to the module 8 may achieve the user's treatment effectively. Even though the pads 102 and 104 help the user align his spine onto the module 8, the entire main mat 11 surface may be configured as an orthotic pad.

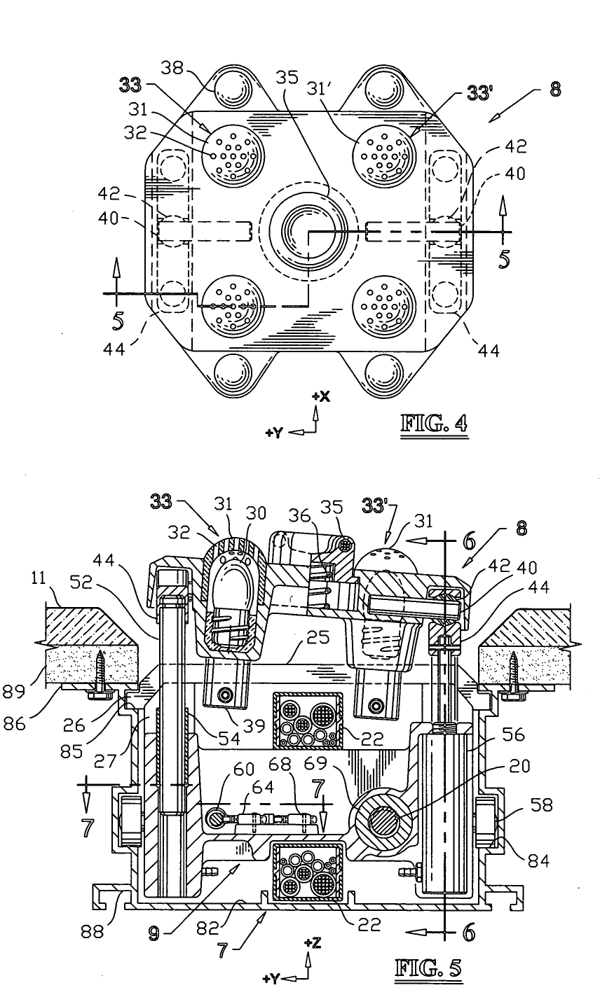

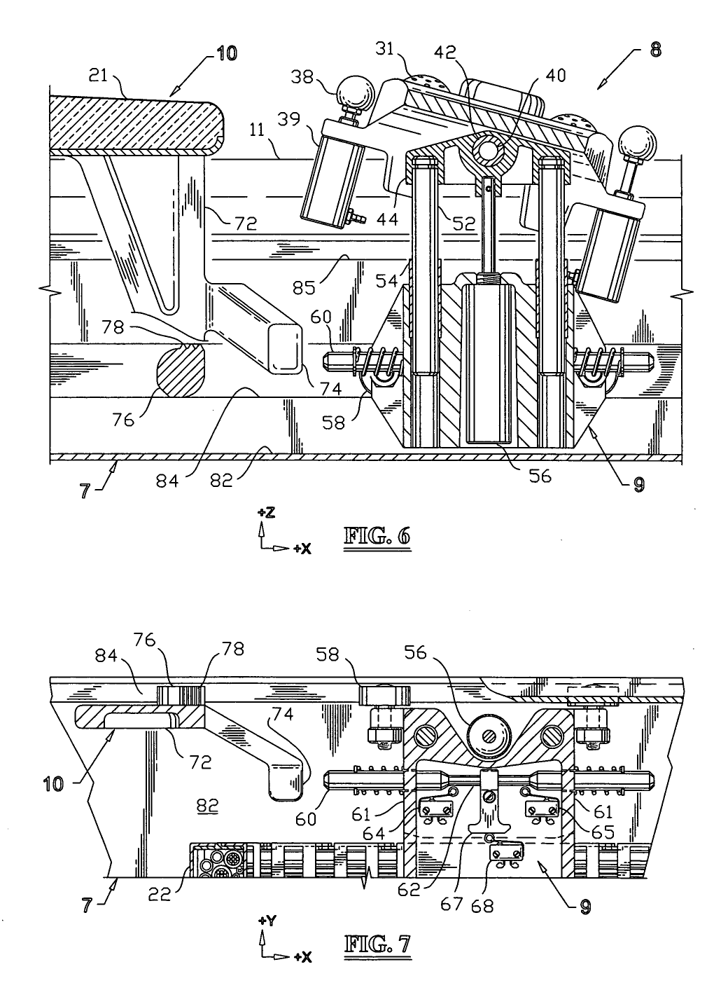

In another exemplary embodiment according to the present invention, FIGS. 4, 5, and 6 show the details of the hot-acupressure and massage module 8 and the saddle 9, both of which are movable on the track 7. The module 8 may have plural heat-transmitting bulbs 30 with caps 31, magnet pulse generators 35, and elastic massage balls 36, which are pivotally supported by two oppositely disposed lateral rods 40. Preferably made of jade, the cap 31 may be generally a tube shape with one end that forms a sphere, or dome, and that may have plural openings 32. The far-infrared rays from the bulb 30 and the cap 31, which may be called a heat-transmitter 33, reach the spinal area for treatment. The distance between two laterally adjoining heat-transmitters 33 and 33′ may be equivalent to the spinal acupuncture points. Alternatively, half of generally peanut shell type unibody cap that has two convexes (equivalent to two heat-transmitters 33 and 33′) and a valley in-between the two convexes may replace two heat-transmitters. The cap 31 may be a roller type to achieve the same treatment effects. There may be plural spring-return actuators such as pneumatic cylinders, air springs or solenoids 39 with elastic balls 38, which are placed adjoining the heat-transmitter 33 to generate massaging/kneading to the spine nerves and muscles for a massaging effect. At least one magnet pulse generator 35 may be disposed on the top plane of the module 8 to transmit a low intensity, low frequency electromagnetic field to the spine and hips. Again, the generator 35 may be preloaded by a spring 36 for the magnet pulse generator 35 to assure contacting the user's body. A third heat-transmitter may be placed in between two heat-transmitters 33 and 33′ to treat the spinous processes, and this may be preloaded with a spring to compensate the protrusion of the spinous processes. The module 8 may have two lateral shafts 40, each connecting ball and socket 42, which is centrally located in two yokes 44. Two yokes 44 may pivotally support the module 8 and each lateral shaft 40 may be linked by ball and socket 42 to achieve total compliance to the shape of the spine. FIGS. 5 and 6 show the module 8 as tilted 5 degrees clockwise (toward the −Y axis) and 15 degrees clockwise (toward the +X axis), respectively. These two X and Y-axes enable the total compliance for the module 8 to conform to the shape of the spine for various users.

In another exemplary embodiment according to the present invention, the user can choose different levels of compression to the user's back from the module 8. This is necessary because each user can tolerate different levels of compression and the weight of the user may vary from under 100 pounds to over 250 pounds. In prior art, the component that is similar to module 8 has to be raised substantially above main mat 11, which resulted in pain onto the user's back. Thus, for these reasons it is desirable for a user to select the proper compression level for his/her back. The lack of compression adjustment may cause insufficient contact between the cap 31 and the back of the user, which results in lack of heat and/or magnetic field transmission to the user's back. The ability to choose different compression levels is especially important for the first-time users. The vertical movement (+Z) of module 8 can be programmed for the user's spine profile by utilizing a microprocessor with a motor, which are mounted on saddle 9. An alternative solution may be an inexpensive pneumatic system. A pair of pneumatic cylinders 56 may lift a pair of yoke 44 that are guided by two pairs of guide rods 52, which slide in two pairs of guide bushings 54. Or an electrical motor with a force gauge or a feedback device may be disposed between the top (+Z) of the motor shaft and at the middle-underneath of the module 8 with compliance, wherein the electric motor may be mounted on the saddle 9. Other examples are to dispose an air cylinder or an air spring between the top (+Z) of the saddle 9 and at the middle-underneath of the module 8 with compliance. This compliance may be a ball and an inner sphere set (ball joint), or a convex and a concave set that generates swivel motion.

Alternatively, laterally disposed one pair of the heat-transmitters 33 and 33′ with a pivot in between may be moved up by an actuator, which is another way to achieve the total compliance. Furthermore, arrays of individual heat-transmitters such as 33 and 33′ with an actuator(s) disposed in the area of the track 7 without the saddle 9 may achieve total compliance with the control of compression onto the user's spine.

The above exemplary features enable the user to select the level of compression by turning a pressure regulator or by manipulating a control pendant. Therefore any user can choose different levels of compression to the user's back from the module 8 and select a comfortable compression force continuously/intermittently by co-relationship of the module 8 traveling in X and Z direction. The sequence of module 8 may be programmed as follows: (1) move up in the Z-direction; (2) stop at 20 pounds force and stay for 45 seconds; (3) drop the force to 2 pounds; (4) move immediately ¾ inch in the X-direction; and repeat the sequence (1), (2), (3) and (4). The repeating on/off and high/low pressure with far-infrared heat by the heat-transmitter 33 and the impact by balls 38 may perform more than human acupressure as practiced by therapists.

A proper amount of heat from heat-transmitters 33 and 33′ into the spine softens vertebras and intervertebral discs. This heat and the properly positioned pads and belts may help correct abnormal spinal conditions such as scoliosis (a lateral or sideways bent), spondylolisthesis (slip or displacement between two vertebra), Kyphosis (a noticeable round back), and lordotic (sway-back). To correct the abnormal spinal condition of a patient, the pads may be moved gradually/step-by-step (±Y or −Z direction in FIGS. 1 and 3) by actuators with programming while the heat softens the user's spine. As an example, for a scoliosis patient, two oppositely disposed pads 102 and 104 or a belt 90 may be placed to secure his hip area in the lateral direction, wherein a third pad may move gradually to apply force (+Y or −Y direction) from the side of his bent-out chest. For a lordotic patient, one of belt ends 95 may be pulled down (−Z direction) by an actuator, or a pad that applies force down can be placed on the his stomach. Chiropractors treat spondylolisthesis patients by pulling their body with reciprocating rollers. These patients may be treated more effectively by securing the patient's upper body with one belt in the hip area and the other belt in the shoulder blade area, and then by gradually pulling the latter belt by an actuator while the heat softens his vertebras and intervertebral discs, which may result in widening the space between the intervertebral discs.

The saddle 9, as shown in FIG. 5, may have a power nut 69 that is normal to the guide rods 52. Thus the rotation of the power screw 20 generates movement of the saddle 9. The power screw 20 may connect to the nut in first saddle 9 and a tube may connect any additional saddle(s) 9′, as shown in FIG. 2. Alternatively, a belting mechanism can replace the requirement of the power screw. There may be one pair of ball bearings 58 on each channel 84 to carry the load of the user's weight.

Referring to FIGS. 6 and 7, when the saddle 9 reaches the user's headrest 21, the switch bracket 74 causes the saddle 9 to stop. The plunger rod 60 may be slidably positioned in the middle of two walls 61; two springs may maintain the rod 60 at a neutral position on the saddle 9. Two receiving holes in the walls 61 for the rod 60 may be parallel to the travel direction (along the X-axis) of the saddle 9. The rod 60 may have a reduced diameter portion 62 in the middle to form two cams that trigger the switch 64 when the rod 60 is pushed in the +X direction (after the saddle 9 had been moving in the −X direction towards the user's headrest). The same concept applies with switch 65 when the saddle 9 moves in the +X direction toward the user's feet. Therefore, the two switches 64 and 65 may cause reciprocation. A power shut-off switch 68 may be placed in between reversing switches 64 or 65, which is activated by a switch cam 67 that is fastened onto the middle of the rod 60 when the reversing switch 64 or 65 fails. Also these reversing switches can be mounted on the switch bracket 74 and 75 to reciprocating the saddle 9 as shown in FIG. 2. Alternatively, an RG linear drive from Amacoil, Aston, Pa. can be used for this reciprocating requirement. This drive has a built-in reversing mechanism with a smooth shaft, which can provide simpler automatic reciprocation for the saddle 9 when coupled with the switch brackets 74 and 75.

The headrest assembly 10 may comprise one pair of extension 72, one pair of locking cam 76, and one switch bracket 74 that may be extended to engage with the rod 60. The locking cam 76 may form a friction portion 78 to lock by itself inside of channel 84 when the headrest assembly 10 is at the rest position.

In this exemplary embodiment according to the present invention, the user can move the pillow 21 by tilting the pillow 21 clockwise, which frees the locking cam 76 from primary channel 84; then, the pillow 21 may be locked by simply pressing down at rest to the desired position according to user's head position. Therefore, this automatic adjustment feature of the headrest assembly 10 is not only able to prevent the hot module 8 from reaching to the user's head, but also to allow accommodating tall and short individuals, to use this body 5 with convenience.

In another exemplary embodiment according to the present invention, to prevent damage to the fabric of covering 24 by the weight of users and to prevent causing discomfort to the user, the embodiment may include floating plates 25 to fill the space in track 7 between the top of modules 8 and 8′ as shown in FIGS. 1 and 2. Occasionally, users sit on arbitrary surfaces such as the non-supported area/space between the modules 8 and 8′, which may cause damage to the covering 24 that is usually made of meshed fabrics. As shown in FIG. 5, the floating support plate 25 may have two transversely extended side wings 26 that slide longitudinally along with the saddle 9, and two opposing upper secondary channels 85 formed inside of track 7 may guide wings 26. The plate 25 may have coupling brackets 27 to the saddle member 9 to travel together and top surface of the plate 25 is substantially lower than the surface of main mat 11.

In another exemplary embodiment according to the present invention, to maximize treatment effects onto the back and lower body of the user, the majority of the top surfaces of mats 11, 14, and 15 may be implemented with means/devices to provide far-infrared rays, electromagnet, ion generator, and massaging (i.e., kneading/tapping) as shown in FIGS. 1-3. An additional belt module 90 can be placed on the chest, abdominal, hip, leg, joints, and feet areas by a main belt 92, whose end 95 is held under the main mat 11, joining mat 14 and/or feet mat 15. Conductors are sealed inside of belt 92. A secondary belt 94 from the opposite side fastens the main belt 92. This belt module 90 may have means/devices that provide far-infrared rays, electromagnet, and massaging (i.e., kneading/tapping) onto the parts of the user besides the back.

In another exemplary embodiment according to the present invention, the user can write, watch television, or work on a computer with a keyboard since the user may spend more than 30 minutes sitting or lying on the body 5. Provision of at least one bracket 106 may be mounted on the sidewall 105 of the main mat 11 or on the frame 6 enable install a structure such as tubing 108, on which a table, handle, or auxiliary appliances can be placed and used.

As shown in FIGS. 5 and 6, the cable and tube carrier 22 may rest on the base plane 82 of the track 7. This carrier 22 may hold wires, power conductors, and pneumatic tubes. The saddle 9 may have an opening at the bottom center to pass over the carrier 22. The carrier 22 may be fastened near the location at which the motor is mounted, and is extended to a location near the headrest assembly 10; the carrier 22 turns its direction 180 degrees and is fastened at the top of the saddle 9.

The cross-section of the track 7 is best shown in FIG. 5. It may be made of extruded aluminum and is generally U-shaped. The track 7 may be comprised of a base plane 82, a pair of nut fastening channels 88 that can be used to connect this track 7 to the frame 6, a pair of secondary channels 85 for floating plate wings 26, and a pair of primary channels 84 for ball bearings 58 to guide/carry load from saddle 9 and locking cams 76. A pair of laterally extended flanges 86 may be provided to fasten the track 7 to the structure board 89 that is under the main mat 11.

In a further exemplary embodiment according to the present invention, hot-acupressure module 8 may be shut off by a feedback from the user's blood pressure level because the warm heat from heat-transmitter 33 to the muscles and nerve tissues of the spinal region directly stimulates the flow of blood for high blood pressure patients. A digital blood pressure device may be connected to body 5 to shut off the power of module 8 whenever the user's high blood pressure is detected.

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come within the meaning and range of equivalents thereof are intended to be embraced therein.

What is claimed is:

1. A hot-acupressure and massage machine comprising:
a body, said body being shaped to support a human being;
a support surface on said body to support a human body;
a slot substantially disposed in said body;
at least one heat-transmitter mounted in said slot to reciprocate in said slot;
a first switch and a second switch to stop and reverse said heat-transmitter movement between a first position and a second position, said first switch having a relationship to said first position and said second switch having a relationship to said second position, and,
at least one of said positions being adjustable.

2. The hot-acupressure and massage machine of claim 1, further comprising a pillow having a position relationship with one of said switches so as to reverse said heat-transmitter movement in position relationship to said pillow position.

3. The hot-acupressure and massage machine of claim 2, wherein said pillow is movable on said body so as to allow a user to select a location of said pillow.

4. The hot-acupressure and massage machine of claim 1, wherein said switch is selected from the group comprising an electric contact switch, a non-contact electronic switch, an encoder, and a mechanical switch.

5. The hot-acupressure and massage machine of claim 1, wherein said heat-transmitter is moved by a device selected from the group comprising: a linear motor; a rotary motor with a nut/screw; a rotary motor with a belt, and a rotary motor with a reversing mechanism and a smooth shaft.

6. The hot-acupressure and massage machine of claim 1, further comprising at least one plate disposed adjoining said heat-transmitter, wherein the surface of said plate is substantially lower than that of said support surface so as to fill the space in said slot.

7. The hot-acupressure and massage machine of claim 1, further comprising a control connected to said heat-transmitter, wherein said control enables shutting off said heat-transmitter when said control detects user's high blood pressure level.

8. A hot-acupressure and massage machine comprising:
a body, said body being configured to support a human being generally a bed or a chair shape;
a first support surface on said body for supporting the back of a human being;
a second support surface for supporting the thighs and feet of the human being;
a slot substantially centrally disposed in said support surface;
at least one heat-transmitter reciprocating in said slot, and,
said second support surface having an angular movement relationship with said first support surface to permit a user to rest comfortably.

9. The hot-acupressure and massage machine of claim 8, further comprising a third support surface, said second support surface having an angular movement relationship with said third support surface so as to rest the thighs on said second support surface and to rest feet on said third support surface.

10. The hot-acupressure and massage machine of claim 9, wherein said secondary support surface is extendable so as to accommodate different thigh lengths of users.

11. The hot-acupressure and massage machine of claim 8, further comprising at least one electric actuator, said actuator being connected to cause angular movement of said first support surface, said angular movement being continuous or discrete.

12. The hot-acupressure and massage machine of claim 9, further comprising at least one electric actuator, said actuator being connected to cause angular movement of said first support surface, said angular movement being continuous or discrete.

13. The hot-acupressure and massage machine of claim 8, further comprising one pair of armrests disposed in said first support surface.

14. The hot-acupressure and massage machine of claim 8, further comprising at least a bracket mounted on said body, and, a structure mounted on said bracket so as to install auxiliary appliance, table, handle or guard.

15. A hot-acupressure and massage machine comprising:
a body, a body being configured to support a human being;
a support surface for a human on said body;
plural heat-transmitters disposed substantially centrally and longitudinally in said body, and,
at least one raised pad disposed on said support surface so as to align a user on said heat-transmitters.

16. The hot-acupressure and massage machine of claim 15 wherein said pad comprises first and second pads disposed on said support surface and oppositely to said heat-transmitters, wherein said first and second pads are movable together simultaneously by means of a self-centering structure.

17. The hot-acupressure and massage machine of claim 15, wherein said pad is inflatable.

18. The hot-acupressure and massage machine of claim 15, wherein said pad is contoured substantially on said support surface so as to help align a user on said heat-transmitter and to provide comfort to a user.

19. The hot-acupressure and massage machine of claim 15, further comprising at least one belt disposed on said support surface.

20. The hot-acupressure and massage machine of claim 15, wherein said pad is movable by an actuator to treat abnormal spinal conditions such as scoliosis, spondylolisthesis, Kyphosis or lordotic by heat from said heat-transmitters and by force from said actuator.

21. The hot-acupressure and massage machine of claim 19, wherein said belt is pullable by an actuator to treat abnormal spinal conditions such as scoliosis, spondylolisthesis, Kyphosis or lordotic by heat from said heat-transmitters and by force from said actuator.

22. The hot-acupressure and massage machine of claim 16, further comprising a movable pillow, wherein said pillow enables the activation of said heat-transmitters only onto a user's spinal areas.

23. A hot-acupressure and massage machine comprising:
a body, said body being configured to support a human being;
a support surface on said body to support a human being, a portion of said support surface having a planar surface;
a track slot substantially centrally disposed in said support surface;
at least one saddle reciprocating inside of said track slot;
at least one hot-acupressure module mounted on said saddle;
at least one heat-transmitter disposed in said module, and,
a compliant structure disposed between said module and said saddle to allow said hot-acupressure module to comply to the shape of the human spine, wherein said compliant structure has a relationship to said planar surface.

24. The hot-acupressure and massage machine of claim 23, wherein said compliant structure is a swivel mechanism selected from the group comprising two-axes pivots, a set of concave/convex spheres, and ball and socket.

25. The hot-acupressure and massage machine of claim 23, further comprising at least one spring disposed between said module and said saddle.

26. The hot-acupressure and massage machine of claim 23, further comprising at least an actuator disposed between said module and said saddle, wherein said module is movable with respect to said saddle.

27. The hot-acupressure and massage machine of claim 26, wherein said actuator is selected from the group comprising a pneumatic cylinder, an air spring and an electric motor.

28. A hot-acupressure and massage machine comprising:
a body, said body being configured to support a human body;
a support structure on said body;
a longitudinal slot positioned substantially centrally in said support surface and extending along a portion of the length thereof;
a plurality of heat-transmitters disposed in said slot;
an actuator, said heat-transmitter being connected to said actuator to be movable in a vertical direction by said actuator, and,
said actuator capable to provide variable force.

29. The hot-acupressure and massage machine of claim 28, wherein said actuator is selected from the group comprising a pneumatic cylinder, an air spring and an electric motor with a force feedback.

30. The hot-acupressure and massage machine of claim 28, further comprising a track disposed substantially centrally in said slot at least one saddle reciprocating in said track; at least one hot-acupressure module mounted on said saddle, said heat-transmitter being disposed in said module and said actuator being disposed between said module and said saddle.

31. The hot-acupressure and massage machine of claim 30, further comprising at least a guide bar mounted on said saddle, wherein said module is slidably mounted on said guide bar.

32. The hot-acupressure and massage machine of claim 30, wherein there are first and second heat transmitters in said module.

33. The hot-acupressure and massage machine of claim 32, further comprising a third heat-transmitter disposed in said module substantially centrally between said first and second heat-transmitters, wherein said third heat-transmitter is spring loaded, the line between said first and second heat-transmitters being substantially normal to the longitudinal direction of said track.

34. The hot-acupressure and massage machine of claim 30, wherein said actuator provides at least one of the modes from the group comprising a continuous, an intermittent, an on, and an off mode with respect to longitudinal position of said saddle so as to simulate human acupressure.

35. The hot-acupressure and massage machine of claim 30, further comprising an auxiliary device selected from the group comprising a massage actuator, an ion generator and an electromagnet generator, wherein, said auxiliary device is mounted on said module.

36. The hot-acupressure and massage machine of claim 30, further comprising an auxiliary device selected from the group comprising a massage actuator, an ion generator and an electromagnet generator, wherein, said device is mounted on said module.
